(19) United States
(12) Patent Application Publication
(10) Pub. No.: US 2008/0242180 A1
(43) Pub. Date: Oct. 2, 2008

(54) JOINTING METHOD FOR SUPPORT STRUCTURE OF FILED EMISSION DISPLAY ELEMENT

(76) Inventors: Guo-Hua CHEN, Taipei City (TW); Frank Yang, Taipei City (TW)

Correspondence Address: HDSL, 4331 STEVENS BATTLE LANE, FAIRFAX, VA, 22033, US

(21) Appl. No.: 11/693,875

(22) Filed: Mar. 30, 2007

(51) Int. Cl. H01J 9/18

(52) U.S. Cl. 445/24

(57) ABSTRACT

A jointing method for the support structure of a FED component is provided for fixing the relative position between the support structure and the electrode plates; first of all, a bearing plate is provided, on which a plurality of grooves spaced in parallel are, in advance, arranged for placing support structures thereon; furthermore, there is a metal jointing layer arranged respectively on the substrates of cathode and anode for aligning and positioning the substrates with respect to the bearing plate having a plurality of support structures, then the plural support structures are pressed together with the metal jointing layer; finally, both the jointed substrates and the bearing plates are simultaneously sent into a vacuum furnace for processing a high temperature sinter procedure, whereby the support structures and the substrates are formed into an eutectic structure through the metal jointing layers; therefore, the relative position between the support structures and substrates is fixed.

### BACKGROUND OF THE INVENTION

1. Field of the Invention

The present invention in general relates to a plane display of field emission type, in particular, to a manufacturing method of support structure for supporting electrode plates.

2. Description of Prior Art

At present, since the emergence of plane display that, not only has replaced the traditional picture display but also, under the characteristics of lightness and thinness, has further developed into application products needing different sizes of displays, such as, the small products of personal mobile phone or digital assistant (PDA) and the large products of commercial signboards commonly seen in outdoors, all of which are applications of plane display.

The category of plane display includes liquid crystalline display (LCD), plasma display panel (PDP) and organized light-emitting diode (OLED) display, etc. On the other hand, the filed emission display (FED), being quickly risen, has become one kind of burgeoning plane displays in recent years. Besides its self-lightening advantage, the FED further has the characteristics of extensively viewing angles, low electric consumption and quick reaction, which are all its advantages superior to those of other types of display. In the meantime, being cooperated with the nano-technology applied in plane display, FED definitely becomes the star of tomorrow in such field.

The basic structure of FED is mainly comprised of an anode plate and a cathode plate, on which are, respectively, provided a phosphor layer and a cathode electron emitter. In addition, there is a support structure placed between the anode plate and the cathode plate to create a vacuum space and a support, so that the vacuum space may provide the electron beam emitted from the cathode electron emitter with a sufficient acceleration space, with corresponding impacts upon the phosphor layer of the anode plate to generate lightening effectiveness. The support structure is, therefore, an important component in the structures constituting a FED.

In order to act as a support assembly between the electrode plates, in the prior arts, the support structure must be secured thereon to avoid the generation of moving phenomenon to influence the accurate position of both plates and the thereby electron impinging position on the phosphor layer. According to one embodiment of the prior arts, a snapping-in method is usually applied; that is, before the structures of the electrode plates and the support structure are formed, a positioning structure is pre-designed, such that the electrode plate and the support structure may be snapped together, but this prior method will be more tedious in manufacturing the electrode plates. While in another embodiment of the prior arts, an interface laminating method is employed, wherein a glass material is melted under high temperature to integrate the electrode plates and the support structure according to corresponding positions thereof. This interface laminating method is often used in current FED industry; however, there is one serious defect existed: organic solution in the glass material will be evaporated into vapor state to pollute the inside vacuum environment, during the high temperature sintering procedure.

In a further prior art disclosed in U.S. Pat. No. 5,717,287, an eutectic technique is adopted, wherein a metal material is acted as jointing interface between the support structure and the electrode plates, whereby a jointing structure may be provided under the processing environment of 300˜500° C. and 500˜2000 volt. This method not only may reduce the manufacturing time, but also may avoid the unnecessary gas emission influencing the vacuum environment during the packaging process. However, under a manufacturing environment of high temperature and high voltage, the electrodes arranged on the anode and the cathode plates and the nano-materials served as the cathode electron emitter will be oxidized, which is a drawback in an otherwise perfect method, because it will directly influence the circuit conduction of the assembled display panel and the emitting effectiveness of the cathode electron emitter.

### SUMMARY OF THE INVENTION

Regarding aforementioned drawbacks, the main objective of the present invention is to provide a jointing method for the support structure of a FED component, wherein an eutectic process is proceeded with high temperature sinter under a vacuum environment, through which needed sinter temperature is reduced, so that a jointing structure between the support structure and the electrode plates is then completed without a need of the voltage environment adopted by the prior arts neither there is any oxidation risk occurred to the electrode arranged upon the substrate and to the cathode electron emitting material.

To achieve above objective, the invention mainly provides a jointing method for the support structure of a FED component; first of all, a bearing plate is provided, on which a plurality of grooves spaced in parallel are arranged for placing support structures thereon in advance; furthermore, there is a metal jointing layer arranged respectively on the substrates of cathode and anode for aligning and positioning the substrates with respect to the bearing plate having a plurality of support structures, then the plural support structures are pressed together with the metal jointing layer; finally, both the jointed substrates and the bearing plates are simultaneously sent into a vacuum furnace for processing a high temperature sinter procedure, whereby the support structures and the substrates are formed into an eutectic structure through the metal jointing layers; therefore, the relative position between the support structures and substrates is fixed.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective view showing the structure of the bearing plate according to the present invention;

FIG. 2 (A), (B) are operational illustrations of the bearing plate according to the present invention; and

FIG. 3 is a jointed illustration according to the present invention.

### DETAILED DESCRIPTION OF THE INVENTION

In cooperation with attached drawings, the technical contents and detailed description of the present invention will be as follows. However, the attached figures are only for the purpose of reference and description, not for limiting the scope of the present invention.

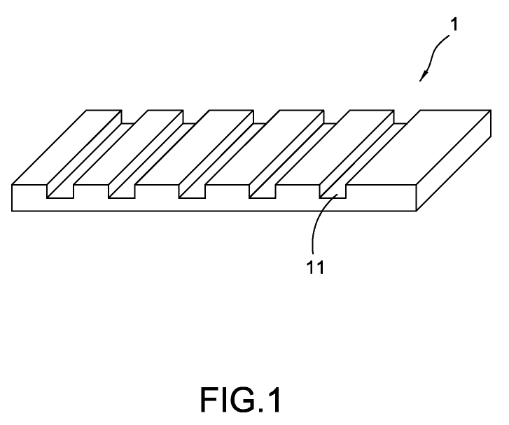

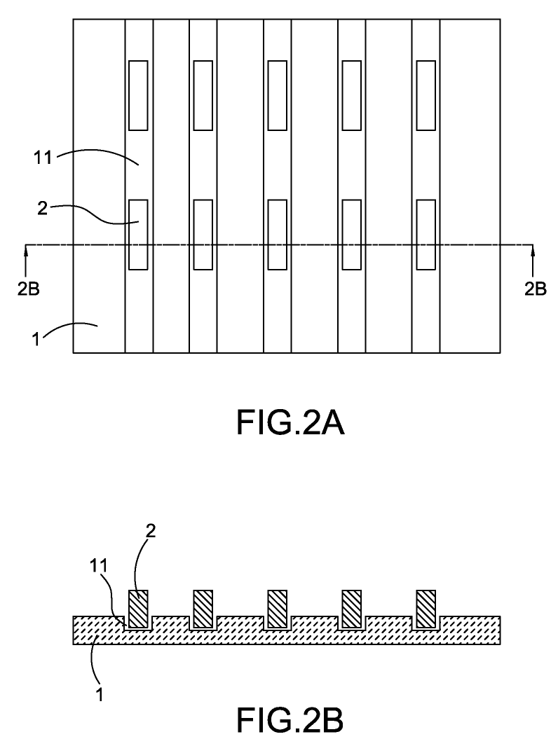

Please refer to FIG. 1 and FIG. 2 (A), (B), which separately are perspective structural view and operational illustration of the bearing plate according to the present invention. The present method, first of all, provides a bearing plate 1, on which a plurality of parallel grooves 11 are arranged for bearing the support structures 2 spacing the electrode plates, as shown in FIG. 1. The support structures 2 are then fixed in an upright position, as shown in the top view and the sectional view of FIG. 2(A) and FIG. 2(B).

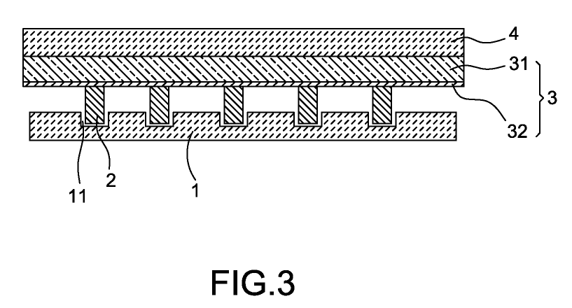

Please refer to FIG. 3, which is a jointing illustration according to the present invention. In this embodiment, the substrate of the anode plate is represented as an example. As shown in this figure, the anode plate 3 includes an anode substrate 31, on its inner surface a metal jointing layer 32 is covered. In this case, the metal jointing layer 32 is an aluminum material for an evaporating deposition. The outer surface of the anode substrate 31 is arranged an upper plate 4 for protecting the other side of the substrate 31. The bearing plate 1 having plural support structures 2 is then positioned correspondingly to the metal jointing layer 32 in such a way that the plural support structures 2 are pressed together with the metal jointing layer 32. At last, both the anode plate 3 and the bearing plate 1 are, simultaneously, sent into the vacuum furnace to undergo a vacuum sinter, whereby the support structures 2 and the anode substrate 31 are formed into an eutectic structure through the metal jointing layer 32. The vacuum condition of the vacuum furnace is set at 10⁻³ torr, while the highest temperature of aluminum material is maintained under 600° C. to avoid the oxidation occurred to the electrodes and the materials served as the cathode electron emitter. In addition, aforementioned processes and conditions may be reapplied to the support structures 2 and the cathode electrode for forming another eutectic structure.

Aforementioned description is only preferable embodiment according to the present invention, being not used to limit its executing scope. Any equivalent variation and modification made according to appended claims is all covered by the claims claimed by the present invention.

What is claimed is:

1. A jointing method for a support structure of a FED component for fixing relative position between the support structure and electrode plates, comprising following steps:
a) providing a bearing plate having a plurality of grooves for bearing a plurality of support structures;
b) arranging a metal joint layer on the surface of a substrate intended to be jointed with the support structures;
c) aligning the bearing plate with the substrate so as to press the support structures together with the metal jointing layer; and
d) sending the bearing plate and the substrate into a vacuum furnace for processing high temperature sinter so as to form an eutectic structure between the support structures and the substrate through the metal jointing layer.

2. The jointing method according to claim 1, wherein the metal jointing layer is an aluminum material.

3. The jointing method according to claim 1, wherein the vacuum condition of the vacuum furnace is at 10⁻³ torr.
